(19) United States
(12) Patent Application Publication
(10) Pub. No.: US 2003/0183482 A1
(43) Pub. Date: Oct. 2, 2003

(54) Sorting conveyor with base module

(76) Inventors: Manfred Boller, Hohentengen (DE); Willy Maier, Wettingen (CH)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/426,869

(22) Filed: May 1, 2003

Related U.S. Application Data
(63) Continuation of application No. PCT/EP01/10923, filed on Sep. 21, 2001.

(30) Foreign Application Priority Data
Nov. 23, 2000 (EP) EP00 125 653.6

(51) Int. Cl. B65G 47/40

(52) U.S. Cl. 198/370.04; 198/360

(57) ABSTRACT

The present invention relates to a sorting unit having tipable troughs that are selectively tipable by a combination of levers and cams running within predefined tracks. The tipping action can be selectively controlled so as to accommodate items within the troughs of varying weights, coefficient of frictions and the like.

### BACKGROUND OF THE INVENTION

The invention relates to a sorting conveyor with a number of transport cars that have laterally tipping delivery troughs for the package freight being sorted.

A sorting conveyor of this type is known from German patent DE 40 42 708 C2. Herein, a sorting conveyor is described which has a series of revolving support units for laterally tipping delivery troughs that are moved along a conveyor chassis past a storage station where they are loaded with the package freight that is to be sorted. The support units loaded with the package freight are then moved past a series of unloading or receiving stations, in which the delivery troughs can be selectively tipped by means of control arms disposed on both sides, so that the package freight being sorted can be unloaded. The support units are implemented as transport cars or transport units with guide elements which engage in the conveyor chassis at a relatively great distance from each other. The transport cars are fitted with elongated drive elements which extend in the direction that the support units are pushed and which are designed to work in conjunction with linear motors. These are attached in fixed positions along the conveyor chassis.

With this type of sorting conveyor it is known that the delivery troughs are tipped by means of a tipping device, with the tipping device engaging the control arm in running slots by means of a cam follower roller, thereby causing the tray to tip.

It is also already known from European patent EP 0 173 399 B1 that the cam follower roller must be engaged in the running slots through a controlled movement at right angles to the direction of travel.

This provides a mechanism for tipping the delivery troughs selectively. Depending on the speed of the conveyor, the tipping of the delivery troughs will also be assisted by the article being sorted, which will slide outwards when the tipping process starts. This is because the center of gravity of the delivery trough will inevitably be shifted outwards towards the unloading station.

There is, however, a fundamental problem with the aforementioned tipping conveyor due to the fact that the items of package freight being tipped can have quite different slide characteristics because of their external features. This can place a considerable mechanical load on the guide running slots, or can even cause the delivery trough to return to its basic position, particularly in the case of comparatively heavy items of package freight that do not slide easily. As a result, another attempt will have to be made to carry out sorting in such a case, or the item in question may even have to be sorted by hand. This will adversely affect the performance of the sorting conveyor.

This problem can be solved by increasing the maximum possible tipping angles. The items of package freight that have a comparatively poor slide characteristic will then be sufficiently accelerated. However, the items of package freight with good slide characteristics could then start to move too fast and could possibly overturn. As a result, the address, which is normally on the top, could end up on the bottom or the side.

This disadvantage could in turn be removed by an appropriate design of the delivery trough. When package freight is being sorted, it must therefore be possible to selectively adapt the sorting conveyor so that different delivery troughs and tipping angles can be implemented in order to meet different requirements. Sorting conveyors known from the prior art are directed away from the following advantages and solutions.

### SUMMARY OF THE INVENTION

An advantage of the present invention is to provide a sorting conveyor that can be especially equipped to meet specific requirements and which can also sort comparatively heavy items of package freight safely and reliably even if they do not have particularly good slide characteristics.

These and other advantages are achieved with a sorting conveyor set out herein, comprising the following features:

the transport cars have a support unit for the delivery troughs that swivels round a tipping axis;

there is a lever arm that can engage in running slots and can act on the support unit;

the transport cars consist of a base module that holds the support unit; and

the base module has guide elements for the tipping movement of the support unit, and it provides a lifting movement of the lever arm that initiates the tipping movement.

Accordingly, the tipping device acts directly on the support unit, so that different delivery troughs can be used and the delivery troughs can be easily replaced. Furthermore, the pressure of the gravitational effect of the item of package freight is cushioned particularly well in the transport cars, because the lever arm engages in the base module that is equipped with the guides, and it is also held there. In addition, the creation of the base module provides a particularly simple design for the transport cars. Thus, for example, a base module comprising two parts is feasible, with the two halves being reverse images of each other and having guide rails in the form of cavities, thereby restricting the mobility of the support unit and of the lever arms in a two-dimensional plane.

Different tipping angles can easily be achieved through the selection of an appropriate base module. So that the structure of the transport cars described above can be used to particular advantage, provision is made for locking the lever arms, and therefore the delivery troughs, in their basic and tipping positions. This makes it possible to retain the delivery troughs securely in their tipping position without the need to engage the tipping mechanism further in a running slot which would otherwise be subjected to a comparatively heavy mechanical stress if the load comprised particularly heavy items of package freight and if these items did not have particularly good slide characteristics. Because engagement in the running slots is shorter, the size of the running slots can be comparatively small, and the noise level suffered by personnel as a result of the deflection roller running in the running slots is comparatively low.

Another particular advantage of the aforementioned design can be utilized by the lever arms engaging in two-dimensional running slots. This is because the lever arm has essentially only to carry out a vertical linear movement, either upwards or downwards, in order to tip the delivery trough. For this purposes it therefore engages in the base module.

A further advantageous embodiment of the invention provides for the lever arm acting on a slide seating on the support unit without a bearing, which means that there is no need for an additional bearing and its assembly.

In an alternative or additional development of the invention, the height of the sorting conveyor will be made low when the delivery troughs can be tipped to both sides, and two moveable lever arms are provided that are independent of each other and that act on the support unit on a slide seating. Accordingly, only one of the two lever arms will be moved upwards or downwards to achieve tipping, with the support unit moving past the other lever arm that has not been activated. This embodiment variant is especially favorable with a lever arm that is active in the upward direction, because the other lever arm is not correspondingly pressed passively downwards. For this reason, there is no need to provide space for this lever arm, which, in the prior art, is typically moved passively.

A particular advantage of this design is that a maximum tipping angle of the support unit can be specified by an appropriate implementation of the guide elements. In this way, different tipping angles can be implemented simply by using correspondingly different base modules, with the lever arms and the support unit as such remaining essentially unchanged.

In a particularly preferred embodiment variant, the lever arm logically has protruding pot-shaped cams. By means of these cams, it engages in an essentially vertical guide rail, with the basic and end positions being implemented by means of a locating position that branches laterally from the guide rail.

This embodiment includes a feature that significantly improves operating reliability. This is that a lever arm that tips the support unit swivels the support unit when the unlocking movement starts so that the other lever arm cannot be unlocked. Operating reliability will also be particularly improved if the aforementioned feature is extended so that the lever arms can be engaged in the running slots by means of a control element that can be engaged in an engaged position, with these elements being slightly offset in relation to each other, seen in the direction of travel. Accordingly, only the following one of the two engaging elements looked at in the direction of travel will be destroyed in the event of a faulty engagement attempt (with both engaging elements set in position). But damage to the transport cars and/or to the running slots will certainly be avoided as a result. The entire sorting conveyor, apart from this one destination position that can no longer be served or that can only be served from one side, can therefore continue to be operated. This helps to ensure a high degree of availability for the sorting conveyor.

An alternative variant to the embodiment explained above provides for a two-part structure of the lever arm with a cover and a deflection lever. The cover engages with a slide seating on the support unit and can essentially move only in a lifting direction, and additionally, the deflection lever runs essentially parallel in the cover. The lever arm has a jointed connection to the cover with its upper end that is turned towards the support unit, and it can be engaged in the running slots with its opposite bottom end. This ensures that only a one-dimensional movement of the lever arm is possible in the base module.

An implementation of the tipping mechanism is as follows. To achieve a tipping and locking movement of the delivery trough, the bottom end of the deflection lever used to unlock the basic position within the dimensions of the cover can be swiveled in an initial direction of swivel. This is in a direction that is essentially vertical to the direction of lift. To achieve the tipping movement, it can move in a lifting direction, and, for locking the tipped end position, it can swivel in a second direction that is anti-parallel to the first direction of swivel.

The aforementioned design makes it possible to implement completely different tipping angles and to lock the tipped position. This can be done easily, without the need to change components, if the base module and the deflection lever have cams and locating positions for the cams that correspond to each other, with the cams and the locating positions being arranged behind each other in the direction of lift.

To make it easier to find the right locking position, a stop can be used to limit the tipping movement for the cover and/or the support unit. This stop can be mounted so that its height can be adjusted.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a schematic representation of a first transport car belonging to a sorting conveyor, with a delivery trough in a basic position and a tipped position;

FIG. 2 depicts a side view of the transport car shown in FIG. 1;

FIG. 3 depicts a schematic representation of a second transport car belonging to a sorting conveyor, with a delivery trough in the basic position;

FIG. 4 depicts the second transport car shown in FIG. 3, with the delivery trough in the tipped position; and

FIG. 5 depicts a schematic representation of a third transport car of a sorting conveyor, with a delivery trough in the tipped position.

### DETAILED DESCRIPTION OF THE INVENTION

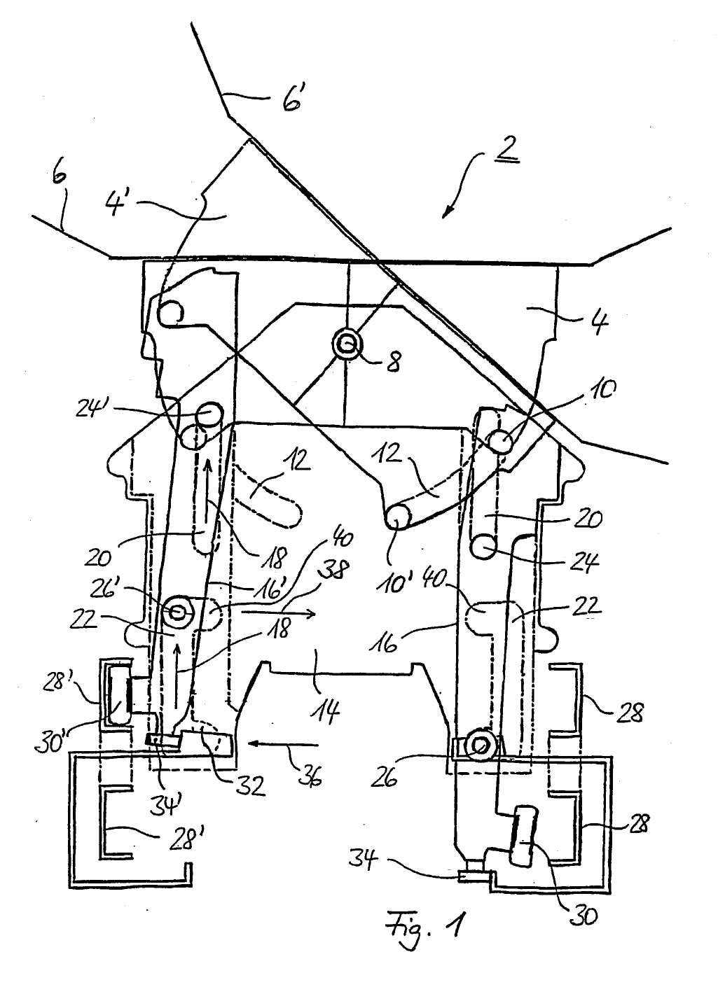

In FIGS. 1 to 5, the same reference characters are used for parts that are structurally similar or identical. When parts are structurally similar or identical, those in the tipped position are marked with an apostrophe (+) to distinguish them from the components in the basic position.

FIG. 1 shows a schematic representation of a first transport car 2, which is part of a revolving chain of transport cars belonging to a sorting conveyor (not shown in further detail). A direction of travel of the sorting conveyor runs vertically to the plane of the diagram. The transport car 2 has a delivery trough 6, 6′ mounted on a support unit 4, 4′ for holding items of package freight, which are not shown here. The support unit 4, 4′ can swivel round an axis 8 parallel to the direction of travel. In the figure, it is shown tipped to the right.

The support unit 4 with cam-shaped pins 10, 10′, is depicted initially engaging with the deflection in an arc-shaped guide rail 12 which is molded in a base module 14. The base module 14 therefore serves to carry the support unit 4, and it represents a connection with the drive elements of the sorting conveyor that are not shown here such as, for example, linear motors—and the neighboring transport cars.

In the base module 14, there are also lever arms 16, 16′. In the present example embodiment, the lever arm 16′ on the left-hand side has caused the delivery trough 6 to tip by means of a lifting movement 18. In the base module 14, guide rails 20, 22 with the associated pins 24, 24′ or 26, 26′ which are disposed on the lever arms 16, 16′ are likewise provided to guide the lever arms 16, 16′.

So that a delivery trough 6, 6′ can be tipped to one side, provision is made for the lever arm on the other side—in this case the lever arm 6′—to engage in the running slots 28, 28′. In the present example embodiment, these specify only a two-dimensional curve in the space that the lever arm 16′ has to follow. To engage lever arm 16′ in the running slot 28, 28′, the lever arms 16, 16′ have a friction bearing mounted cam follower roller 30, 30′, which is engaged in the running slot 28, 28′ by means of an engaging element (not shown).

So that the lever arm 16′ can, however, carry out the lifting movement 18, the lever arm 16′ must first be unlocked. The locking includes the fact that roller bearing mounted pin 26′ is placed in the parked position in the first projection 32, which is to the side of the guide rail 22 and is part of the guide rail 22, and it is swiveled by means of a deflection roller 34 in an initial direction of swivel 36. The deflection roller 34 could therefore be dispensed with, because, with an appropriately designed engaging element, the function of deflection roller 34 could be achieved by direct contact with the cam follower roller. The first direction of swivel 36 is essentially vertical to the lifting movement 18. The first swiveling movement is around the axis of the pin 24′. This is followed by the lifting movement 18, with the tipping of the support unit 4′ and of the delivery trough 6′. This tipping movement is depicted. Finally, to lock the tipped position, a movement takes place in a second direction of swivel 38, which is anti-parallel to the first direction of swivel 36. The roller bearing mounted pin 26′ then rests in a second projection 40 laterally at the end of the vertically inclined section of the guide rail 22, and it can no longer be pressed directly either upwards or downwards. This ensures that the delivery trough 6′ is maintained permanently in the tipped position until the transport car 2 passes a reset running slot (not shown) and a reverse sequence of the movement of the lever arm 16′ takes place.

The transfer of the lifting movement 18 from the lever arm 16′ to the support unit 4′ is achieved by a slide seating of the lever arm 16′ at an abutment of the support unit 4′. This ensures that the other lever arm 16 is also not moved. The amount of space required downwards is therefore much less than in the case of a lever arm that swivels downwards. In addition, the support unit 4′ is swiveled at the same time as the lifting movement 18 starts, so that a lifting movement of the lever arm 16 is blocked. Because of the length of the guide rails 20, 22 and the arc-shaped section of the guide rail 12, the required tipping angles can also be set within broad limits. The support unit 4, 4′ and the lever arms 16, 16′ can remain unchanged.

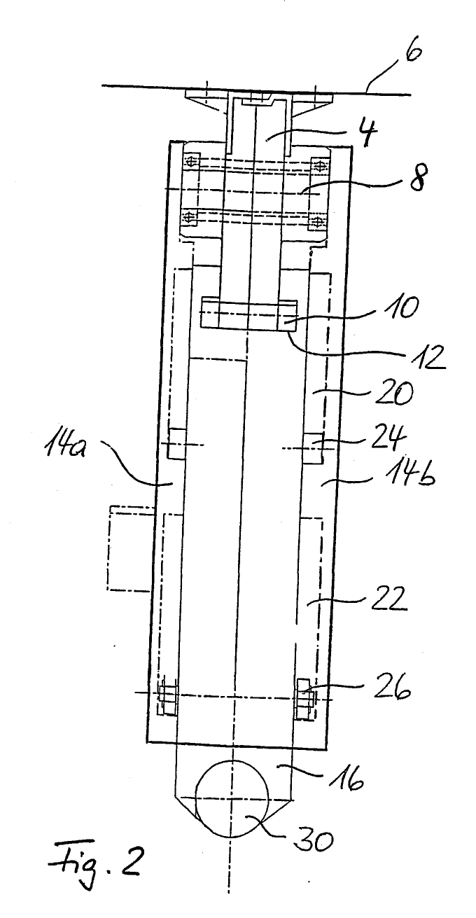

FIG. 2 depicts a side view of the transport car 2. In this view, it is particularly clear that the base module 14 has two parts, namely 14a and 14b, which are mirror images of one another. In this way, the support unit 4 and the lever arms 16 are particularly well engaged in the internal guide rails 12, 20, and 22.

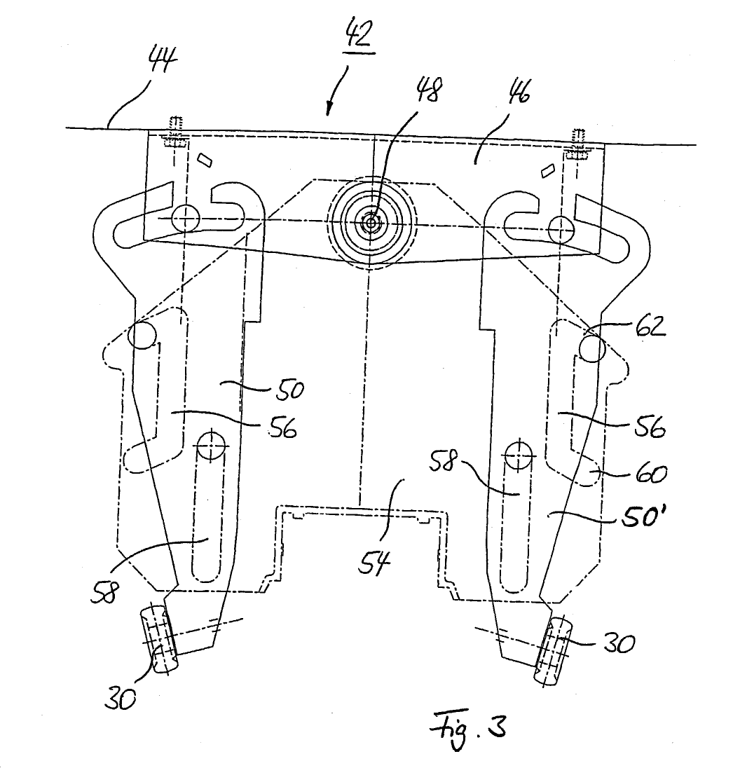

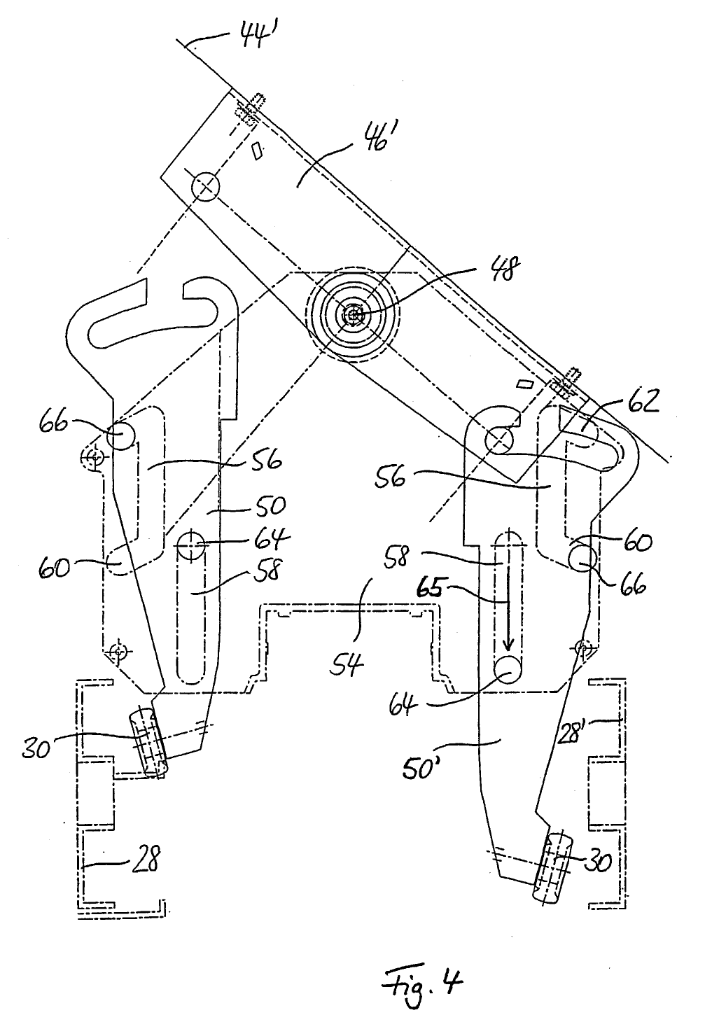

FIG. 3 shows a second transport car 42 belonging to a sorting conveyor which is not shown further here. In this case as well provision is made for a support unit 46 that carries the delivery trough 44 and which can rotate around the axis 48. The support unit 46 and the lever arms 50, 50′ are in turn held in a base module 54. To guide the lever arms 50, 50′, the guide rails 56, 58 are likewise provided in a base module 54, with the guide rails 56 having two projections 60 and 62. The top projection 62 is used for locking the basic position of the delivery trough 44. Likewise, the bottom projection 60 is used for locking the tipped position, as shown in FIG. 4. The lever arms 50, 50′ have in addition cam-shaped pins 64, 66, by means of which guiding is achieved in the guide rails 56 and 58.

As depicted in FIG. 4, the difference between this example embodiment and the previous example embodiment shown in FIGS. 1 and 2 is that that the support unit 46 is not pushed upwards by a pushing movement (lifting movement 18), but is instead drawn downwards by a pulling movement (lifting movement 65). The remaining procedure for unlocking and locking the two positions of the delivery trough 44 has therefore been adopted in this example embodiment. As set out above, a movement of the swivel arm 50′ on its cam follower roller 30′, which can be engaged in the running slot 28′, is provided here in the first and second direction of swivel 36 or 38, as the case may be. Even in the case of this example embodiment, only one of the two lever arms 50, 50′ is moved to produce the tipping movement.

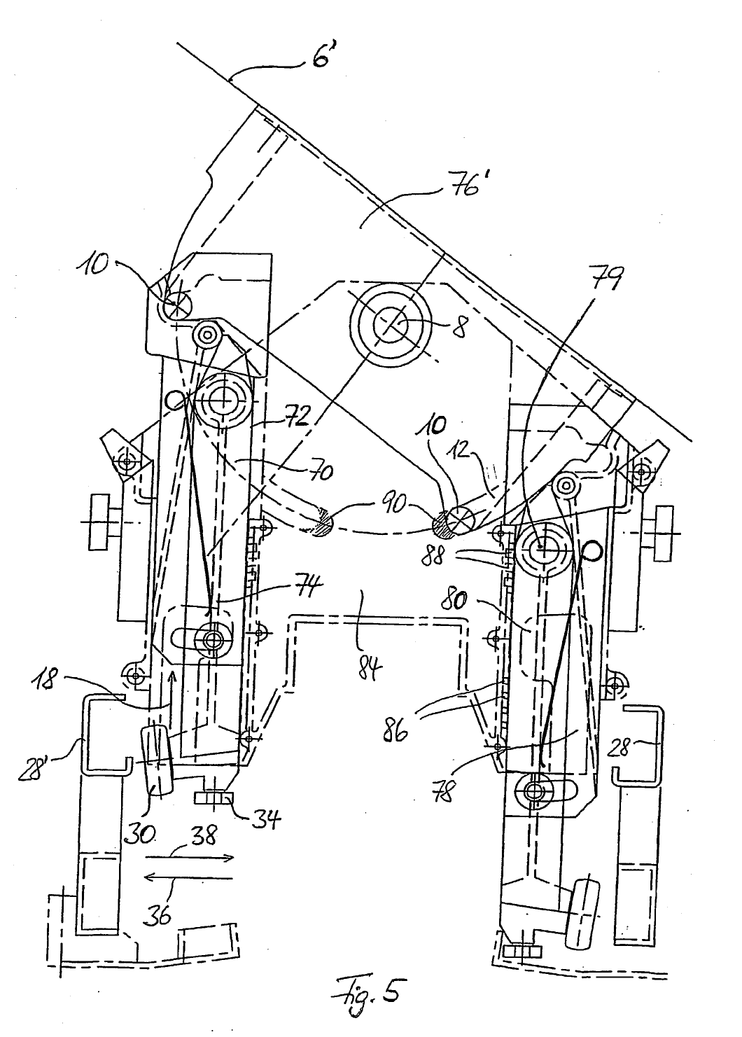

FIG. 5 depicted a third transport car 68. In contrast to the previous example embodiments, a two-part lever arm 70 with a modified functional mechanism is used here. All the other functional mechanisms follow the principles set out above with respect to the two previous example embodiments.

The lever arm 70 has a cover 72 and a swivel rod 74. The cover 72 engages a slide seating on a support unit 76′ for the delivery trough 6, 6′, and it can essentially only be moved in the lifting direction 18. The swivel rod 74 is disposed running in the cover 72. The top end facing the support unit 76 can be rotated in a bearing 79. It is connected to the cover 72. The opposite bottom end with the cam follower roller 30 can be engaged in the running slot 28, 28′.

In the present example embodiment, the tipping and locking movement of the delivery trough 6, 6′ is achieved by swiveling the bottom end of the swivel rod 74 for releasing the locked basic position within the dimensions of the cover 72 in the first direction of swivel 36. Through this swiveling movement, the roller bearing mounted pin 26, 26′ is moved out of the first projection 80 belonging laterally to the vertical guide rail 78, and is then moved, together with the cover element 72, in the lifting direction 18 in order to bring about the tipping movement. To lock the tipped end position, the swivel rod 74 is swiveled in the second direction of swivel 38—which is anti-parallel to the first direction of swivel 36—into a second projection 82.

A special feature of this example embodiment is that the tipping angle that can be achieved can be variable adjustments within certain limits. For this purpose, a base module 84, which carries the cover 72 and the support unit 76, and the swivel rod 74, have cams 86 and locating positions 88 for the cams 86 corresponding to each other, with the cams 86 and the locating positions 88 being behind each other in the lifting direction 18.

To make it easier to find the required position of cams 86 and the locating positions 88 relative to each other—which can be sensitive because of the comparatively fine grid—a stop 90 is provided to limit the tipping movement for the support unit 76. This stop 90 is implemented in the present embodiment as a part that can be inserted in the guide rail 12, in which the support unit 76 is engaged with its pins 10. Alternatively, stop 90 can also be provided for the cover 72 to limit its lifting movement 18. This would have the additional advantage that, with a stop 90 that could be adjusted for height, the maximum tipping angle could be set from outside. Another possible alternative is to have the delivery trough come up against a stop during the tipping movement. The position of this stop could in turn be set, such as, for example, by means of a running slot. This means that, within a sorting conveyor with one and the same transport car, different tipping angles can be implemented to suit the prevailing requirements.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

In the claims:

1. A sorting conveyor including transport cars having laterally tipping delivery troughs for handling package freight, comprising:
a support unit for said transport cars, said support unit swiveling about a tipping axis thereby facilitating trough delivery;
a lever arm for engaging a running slot and acting upon said support unit;
said transport cars comprising a base module that takes said support unit; and
said base module having guides facilitating tipping movement of said support unit and providing a lifting movement of said lever arm thereby initiating said tipping.

2. The sorting conveyor according to claim 1, wherein said delivery troughs are held locked in a basic position and a tipped position.

3. The sorting conveyor according to claim 2, wherein said lever arm is movable into a locking position, said position being substantially vertical to a lifting direction.

4. The sorting conveyor according to claim 1, wherein said lever arm is engagable with a running slot.

5. The sorting conveyor according to claim 1, wherein said lever arm acts on a slide seating, bearing-free, on said support unit.

6. The sorting conveyor according to claim 1, wherein said delivery troughs are tipable in direction of its sides and said conveyor further comprises two independently movable lever arms which act on a slide seating on said support unit.

7. The sorting conveyor according to claim 1, wherein said base module further comprises guide rails for facilitating tipping movement of said support unit and lifting and locking movement of said lever arms.

8. The sorting conveyor according to claim 7, wherein said supporting unit comprises a maximum tipping angle specified through an appropriate embodiment of said guides.

9. The sorting conveyor according to claim 7, wherein said lever arm comprises protruding pot-shaped cams and is guided by means of said cams operating within an essentially vertical guide rail, with the basic and end positions being implemented by means of a locating position branching laterally from said guide rail.

10. The sorting conveyor according to claims 7, wherein one of said two lever arms tips and swivels said support unit, such that when said unlocking movement commences, an other of said two lever arms is blocked from unlocking.

11. The sorting conveyor according to claim 10, wherein said two lever arms can be engaged in said running slot by means of an engaging component that can be moved into an engaging position, with the engaging components being slightly offset in relation to each other in a direction of travel.

12. The sorting conveyor according to claim 1, wherein said lever arm comprises two parts, a cover, and a deflection lever, said cover engaging a slide seating on said support unit and essentially movable only in said lifting direction, said deflection lever running essentially parallel in said cover with its top end facing the support unit being joined with said cover and with its opposite bottom end engaging said running slot.

13. The sorting conveyor according to claim 12, wherein a tipping and locking movement of said delivery trough is effected by said bottom end of said deflection lever which is used for releasing a locked basic position within said cover, and said lever being able to swivel in a first direction of swivel, said direction being essentially vertical to said lifting direction, and being able to be moved to achieve said tipping movement and said lifting direction, and, for locking said tipped end position, being able to swivel in a second direction of swivel that is anti-parallel to said first direction of swivel.

14. The sorting conveyor according to claim 12, wherein said base module and said deflection lever comprise cams and locating positions said cams corresponding to each other, with said cams and said locating positions being disposed behind each other in said lifting direction.

15. The sorting conveyor according to claim 14, wherein a stop is provided to limit tipping movement of said cover and said support unit.

16. The sorting conveyor according to claim 14, wherein a stop is provided to limit tipping movement of said cover or said support unit.
